(19) United States
(12) Patent Application Publication
(10) Pub. No.: US 2026/0281678 A1
(43) Pub. Date: Sep. 17, 2026

(54) SETTING MANAGEMENT SYSTEM, NON-TRANSITORY COMPUTER READABLE MEDIUM AND CONTROL METHOD

(71) Applicant: FUJIFILM Business Innovation Corp., Tokyo (JP)

(72) Inventors: Yuji ONOZAWA, Kanagawa (JP); Atsushi MORI, Kanagawa (JP); Kiyoshi YASUKAWA, Kanagawa (JP); Yusuke TAGUCHI, Kanagawa (JP); Masahiko HARADA, Kanagawa (JP); Akira SHINADA, Kanagawa (JP)

(73) Assignee: FUJIFILM Business Innovation Corp., Tokyo (JP)

(21) Appl. No.: 19/333,008

(22) Filed: Sep. 18, 2025

(30) Foreign Application Priority Data
Mar. 17, 2025 (JP) 2025-042171

(51) Int. Cl. H04W 4/50; H04W 84/18; H04W 88/18

(52) U.S. Cl. CPC H04W 4/50; H04W 84/18; H04W 88/18

(57) ABSTRACT

A setting management system includes an information processing system; a management server that manages setting information on the information processing system; and a user terminal that is able to communicate with the information processing system and the management server; wherein a processor in the user terminal is configured to: acquire device information from the information processing system by communicating with the information processing system; transmit to the management server the device information that is acquired; acquire the setting information corresponding to the device information from the management server; and transmit to the information processing system the setting information that is acquired.

### CROSS-REFERENCE TO RELATED APPLICATIONS

This application is based on and claims priority under 35 USC 119 from Japanese Patent Application No. 2025-042171 filed Mar. 17, 2025.

### BACKGROUND

### (i) Technical Field

The present disclosure relates to a setting management system, a non-transitory computer readable medium and a control method.

### (ii) Related Art

Japanese Unexamined Patent Application Publication No. 2021-135994 discloses a maintenance system of multiple apparatuses that easily sets up an environment where a cloud service is provided using mobile devices.

### SUMMARY

Aspects of non-limiting embodiments of the present disclosure relate to providing a setting management system, a non-transitory computer readable medium and a control method that enables a person, if not a specialist, to set an information processing system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a setting management system including an information processing system; a management server that manages setting information on the information processing system; and a user terminal that is able to communicate with the information processing system and the management server; wherein a processor in the user terminal is configured to: acquire device information from the information processing system by communicating with the information processing system; transmit to the management server the device information that is acquired; acquire the setting information corresponding to the device information from the management server; and transmit to the information processing system the setting information that is acquired.

### BRIEF DESCRIPTION OF THE DRAWINGS

Exemplary embodiment of the present disclosure will be described in detail based on the following figures, wherein:

FIG. 1 illustrates the system configuration of a setting management system of an exemplary embodiment of the disclosure;

FIG. 2 is a block diagram illustrating the hardware configuration of a management server in the setting management system;

FIG. 3 is a block diagram illustrating the hardware configuration of an image forming apparatus in the setting management system;

FIG. 4 is a block diagram illustrating the hardware configuration of a user terminal in the setting management system;

FIG. 5 is a flowchart illustrating the flow of a process performed when initial setting is performed on the image forming apparatus in the setting management system; and

FIG. 6 illustrates the flow of a process performed when the initial setting is performed on the image forming apparatus in the setting management system.

### DETAILED DESCRIPTION

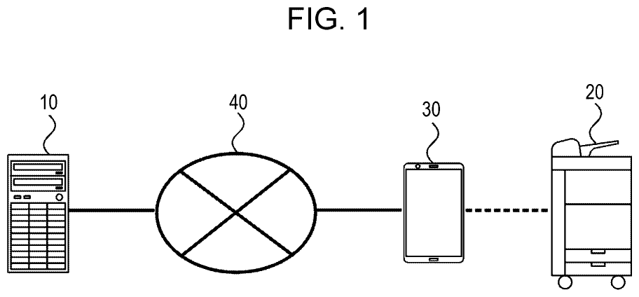

Technique of an exemplary embodiment of the disclosure is described in detail below with reference to the drawings. FIG. 1 illustrates the system configuration of a setting management system of the exemplary embodiment.

Referring to FIG. 1, the setting management system of the exemplary embodiment includes a management server 10, multiple image forming apparatuses 20, and the user terminal 30.

The setting management system enables a user to use the user terminal 30 to set up the image forming apparatus 20.

The management server 10 is used to manage setting information on the image forming apparatus 20.

The image forming apparatus 20 is a multi-function apparatus that has a copying function, printing function, fax function, scanning function and other functions. The image forming apparatus 20 is an example of an information processing system in the exemplary embodiment of the disclosure.

The user terminal 30 is used to set up the image forming apparatus 20 and is configured to communicate with the management server 10 and image forming apparatus 20. Specifically, the user terminal 30 communicates with the management server 10 via the Internet 40. The user terminal 30 also wirelessly communicates with the image forming apparatus 20. More in detail, the user terminal 30 performs ad-hoc communication with the image forming apparatus 20 using connection information that is acquired from the image forming apparatus 20 by performing near-field communication with the image forming apparatus 20. Note that the communication method between the user terminal 30 and the management server 10 and the communication method between the user terminal 30 and the image forming apparatus 20 are not limited to the communication methods described above.

The user terminal 30 may be a smart phone, tablet, laptop computer or the like.

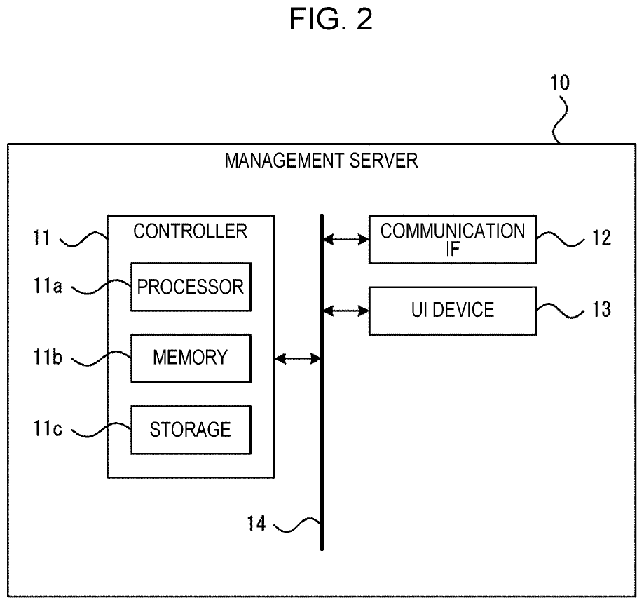

The hardware configuration of the management server 10 of the exemplary embodiment is described below. FIG. 2 is a block diagram illustrating the hardware configuration of the management server 10.

Referring to FIG. 2, the management server 10 includes a controller 11, communication interface (IF) 12, and user interface (UI) device 13. Those elements are interconnected to each other via a control bus 14.

The controller 11 includes a processor 11a, memory 11b, and storage 11c. The processor 11a performs a predetermined process in accordance with a program read from the storage 11c and stored on the memory 11b. The storage 11c may be a read-only memory (ROM), hard-disk drive (HDD), solid-state drive (SSD), or the like. The storage 11c stores a variety of programs, data and the like.

According to the exemplary embodiment, the processor 11a retrieves a program from the storage 11c and executes the retrieved program but the disclosure is not limited to this method. The program may be delivered in a recorded form on a computer readable recording medium. Also, the program may be acquired from an external apparatus via a communication network.

The communication IF 12 has, for example, a network communication function and transmits data to or receives data from an external apparatus or the like. The UI device 13 is used by a user to enter information and includes a mouse and/or keyboard.

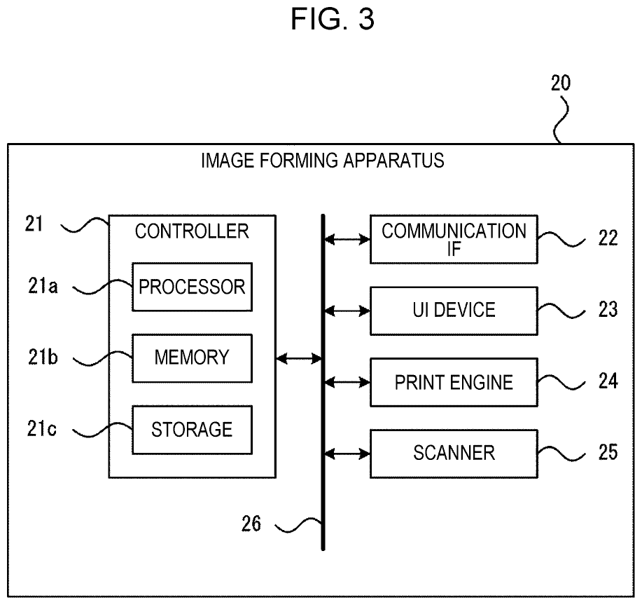

The hardware configuration of the image forming apparatus 20 of the exemplary embodiment is described below. FIG. 3 is a block diagram illustrating the hardware configuration of the image forming apparatus 20.

Referring to FIG. 3, the image forming apparatus 20 includes a controller 21, communication interface (IF) 22, UI device 23, print engine 24, and scanner 25. Those elements are interconnected to each other via a control bus 26.

The controller 21 includes a processor 21a, memory 21b, and storage 21c. The processor 21a retrieves a program from the storage 21c and loads the program onto the memory 21b and then performs a specific process in accordance with the program. The storage 21c may include a ROM, HDD, SSD, or the like. The storage 21c stores a variety of programs, data and the like.

According to the exemplary embodiment, the processor 21a retrieves the program from the storage 21c and executes the program. The disclosure is not limited to this method. The program may be delivered in a recorded form on a computer readable recording medium. Also, the program may be acquired from an external apparatus via a communication network.

The communication IF 22 has a network communication function, near-field communication (NFC) function using an NFC card or integrated circuit (IC) card, ad-hoc communication function, such as wireless fidelity (Wi-Fi) Direct, or other function and transmits data to or receives data from an external device or the like.

The UI device 23 is used by the user to receive or enter information and includes a touch panel and/or buttons. The print engine 24 prints an image on a recording medium, such as a print paper sheet, through steps including charging, exposure, development, transfer, and fixing. The scanner 25 reads as image data an original document loaded on the image forming apparatus 20.

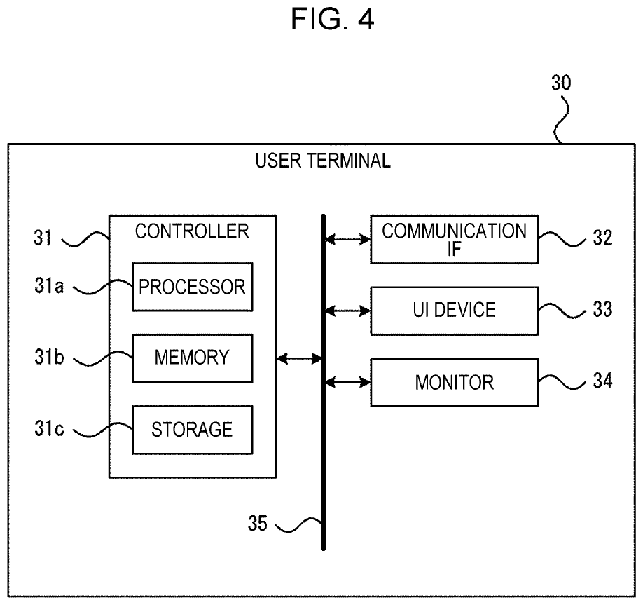

The hardware configuration of the user terminal 30 of the exemplary embodiment is described below. FIG. 4 is a block diagram illustrating the hardware configuration of the user terminal 30.

Referring to FIG. 4, the user terminal 30 includes a controller 31, communication IF 32, UI device 33, and monitor 34. Those elements are interconnected to each other via a control bus 35.

The controller 31 includes a processor 31a, memory 31b, and storage 31c. The processor 31a retrieves a program from the storage 31c and loads the program onto the memory 31b and then performs a specific process in accordance with the program. The storage 31c may include a ROM, HDD, SSD, or the like. The storage 31c stores a variety of programs, data and the like.

According to the exemplary embodiment, the processor 31a retrieves the program from the storage 31c and executes the program. The disclosure is not limited to this method. The program may be delivered in a recorded form on a computer readable recording medium. Also, the program may be acquired from an external apparatus via a communication network.

The communication IF 32 has a network communication function, near-field communication (NFC) function using an NFC card or integrated circuit (IC) card, ad-hoc communication function, such as wireless fidelity (Wi-Fi) Direct, or other function and transmits data to or receives data from an external device or the like. The UI device 33 is used by the user to enter information and includes a touch panel, mouse and/or keyboard. The monitor 34 displays a variety of types of information. If the UI device 33 includes a touch panel, the touch panel serves as the monitor 34.

Expertise is to be used to set the image forming apparatus 20. In particular, a novice has difficulty in performing initial setting on the image forming apparatus 20. In view of this, a system that may enable a person, if not a specialist, to set the image forming apparatus 20 may be useful.

A setting management system of the exemplary embodiment may meet those needs. The controller 31 in the user terminal 30 acquires device information from the image forming apparatus 20 by communicating with the image forming apparatus 20, transmits the acquired device information to the management server 10, acquires setting information responsive to the device information from the management server 10, and transmits the setting information to the image forming apparatus 20.

According to the exemplary embodiment, the controller 31 in the user terminal 30 receives additional information as an input, may transmit to the management server 10 the device information acquired from the image forming apparatus 20 and the input additional information, and may acquire from the management server 10 the setting information corresponding to the device information and additional information.

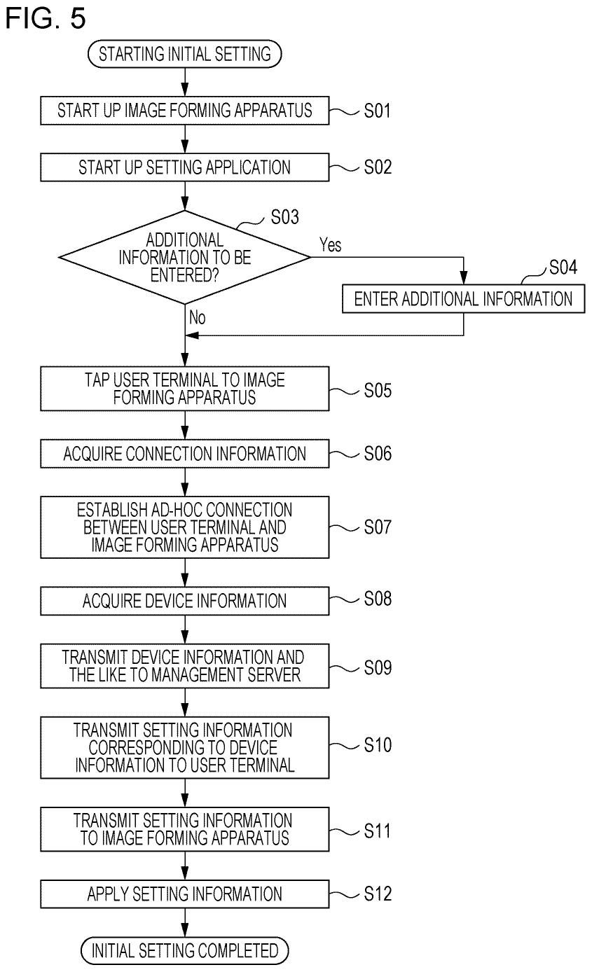

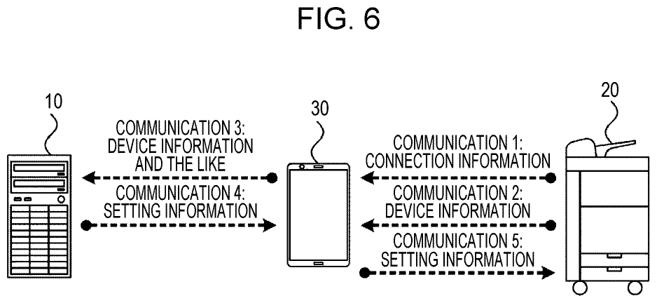

A process of performing the initial setting on the image forming apparatus 20 in the setting management system of the exemplary embodiment is described with reference to FIGS. 5 and 6. FIG. 5 is a flowchart illustrating the flow of the process performed when the initial setting is performed on the image forming apparatus 20. FIG. 6 illustrates the flow of the process performed when the initial setting is performed on the image forming apparatus 20.

The processes described below are performed by the respective controllers of the management server 10, image forming apparatus 20, and user terminal 30 but for convenience of explanation, it is assumed in the following discussion that the processes are respectively performed by the management server 10, image forming apparatus 20, and user terminal 30.

The installer of the image forming apparatus 20 is a person in charge of installing the image forming apparatus 20, for example, a service engineer, administrative user, general user or the like. Note that the image forming apparatus 20 is at factory settings.

To start up the initial setting on the image forming apparatus 20 as illustrated in FIG. 5, the installer first starts up the image forming apparatus 20 in step S01.

The installer starts up a setting application on the user terminal 30 in step S02.

The setting application has a function of receiving additional information including department information and vendor information on the image forming apparatus 20 that that is to be installed as appropriate.

If the additional information is to be entered in steps S03 and S04, the installer enters the additional information.

The installer taps the user terminal 30 to the image forming apparatus 20 in step S05.

In step S06, the user terminal 30 (setting application) acquires from the image forming apparatus 20 connection information used to perform ad-hoc communication with the image forming apparatus 20 via near-field communication (as denoted by communication 1 in FIG. 6). The connection information includes, for example, service set identifier (SSID) of the image forming apparatus 20.

Using the connection information acquired from the image forming apparatus 20, the user terminal 30 establishes the ad-hoc communication with the image forming apparatus 20 in accordance with a generic protocol, such port 9100 in step S07.

The user terminal 30 acquires device information from the image forming apparatus 20 in step S08 (as denoted by communication 2 in FIG. 6). The device information includes a model ID, version, device ID, and configuration information on the image forming apparatus 20.

When the additional information is entered, the user terminal 30 transmits in step S09 to the management server 10 the device information acquired from the image forming apparatus 20 together with the additional information (as denoted by communication 3 in FIG. 6).

In step S10, the management server 10 transmits to the user terminal 30 setting information corresponding to the device information acquired from the user terminal 30 (as denoted by communication 4 in FIG. 6). The setting information is also referred to cloning data.

The management server 10 may manage the device information and setting information in an associated form and transmit to the user terminal 30 the setting information associated with the acquired device information.

The management server 10 may generate the setting information that reflects contents of the device information acquired from the user terminal 30 on a template of setting information and transmit the generated setting information to the user terminal 30.

In that case, the management server 10 may generate a virtual device having the same setting item as in the image forming apparatus 20, and generate the setting information that reflects contents of the device information acquired from the user terminal 30 on the virtual device serving as a template of setting information.

The user terminal 30 transmits to the image forming apparatus 20 the setting information acquired from the management server 10 in step S11 (as denoted by communication 5 in FIG. 6).

In step S12, the image forming apparatus 20 completes the initial setting thereon by applying on the image forming apparatus 20 the setting information acquired from the user terminal 30.

As described above, the installer may perform the initial setting on the image forming apparatus 20 by simply operating the user terminal 30. A person, if not a specialist, may thus perform the initial setting on the image forming apparatus 20.

### Modifications

The setting management system of the exemplary embodiment of the disclosure has been described and the disclosure is not limited to the technique of the exemplary embodiment and may be appropriately modified.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The “system” in the exemplary embodiment may be configured to include a single apparatus or multiple apparatuses.

The technique of the exemplary embodiment in the disclosure may be applicable to a program and/or a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A setting management system including:
an information processing system;
a management server that manages setting information on the information processing system; and
a user terminal that is able to communicate with the information processing system and the management server,
wherein a processor in the user terminal is configured to:
   acquire device information from the information processing system by communicating with the information processing system;
   transmit to the management server the device information that is acquired;
   acquire the setting information corresponding to the device information from the management server; and
   transmit to the information processing system the setting information that is acquired.
(((2)))

In the setting management system according to (((1))), the user terminal performs wireless communication with the information processing system.
(((3)))

In the setting management system according to (((2))), the processor in the user terminal is configured to perform ad-hoc communication with the information processing system using connection information that is acquired from the information processing system by performing near-field communication with the information processing system.
(((4)))

In the setting management system according to one of (((1))) through (((3))), the processor in the user terminal is configured to:
receive additional information;
transmit to the management server the device information acquired from the information processing system and the additional information that is received; and
acquire from the management server the setting information corresponding to the device information and the additional information.
(((5)))

In the setting management system according to one of (((1))) through (((4))), a processor in management server is configured to:
generate the setting information that reflects, on a template of the setting information, contents of the device information acquired from the user terminal; and
transmit to the user terminal the setting information that is generated.
(((6)))

In the setting management system according to (((5))), the processor in the management server is configured to:
generate a virtual device having a setting item identical to a setting item of the information processing system; and
generate the setting information that reflects, on the virtual device serving as the template of the setting information, contents of the device information acquired from the user terminal.
(((7)))

A program causing a computer to execute a process controlling an operation of a user terminal in a setting management system including an information processing system, a management server that manages setting information on the information processing system, and the user terminal that is able to communicate with the information processing system and the management server, the process including:
acquiring device information from the information processing system by communicating with the information processing system;
transmitting to the management server the device information that is acquired;
acquiring the setting information corresponding to the device information from the management server; and
transmitting to the information processing system the setting information that is acquired.

What is claimed is:

1. A setting management system comprising:
an information processing system;
a management server that manages setting information on the information processing system; and
a user terminal that is able to communicate with the information processing system and the management server,
wherein a processor in the user terminal is configured to:
acquire device information from the information processing system by communicating with the information processing system;
transmit to the management server the device information that is acquired;
acquire the setting information corresponding to the device information from the management server; and
transmit to the information processing system the setting information that is acquired.

2. The setting management system according to claim 1, wherein the user terminal performs wireless communication with the information processing system.

3. The setting management system according to claim 2, wherein the processor in the user terminal is configured to perform ad-hoc communication with the information processing system using connection information that is acquired from the information processing system by performing near-field communication with the information processing system.

4. The setting management system according to claim 1, wherein the processor in the user terminal is configured to:
receive additional information;
transmit to the management server the device information acquired from the information processing system and the additional information that is received; and
acquire from the management server the setting information corresponding to the device information and the additional information.

5. The setting management system according to claim 1, wherein a processor in the management server is configured to:
generate the setting information that reflects, on a template of the setting information, contents of the device information acquired from the user terminal; and
transmit to the user terminal the setting information that is generated.

6. The setting management system according to claim 5, wherein the processor in the management server is configured to:
generate a virtual device having a setting item identical to a setting item of the information processing system; and
generate the setting information that reflects, on the virtual device serving as the template of the setting information, contents of the device information acquired from the user terminal.

7. A non-transitory computer readable medium storing a program causing a computer t execute a process of controlling an operation of a user terminal in a setting management system including an information processing system, a management server that manages setting information on the information processing system, and the user terminal that is able to communicate with the information processing system and the management server, the process comprising:
acquiring device information from the information processing system by communicating with the information processing system;
transmitting to the management server the device information that is acquired;
acquiring the setting information corresponding to the device information from the management server; and
transmitting to the information processing system the setting information that is acquired.

8. A method of controlling an operation of a user terminal in a setting management system including an information processing system, a management server that manages setting information on the information processing system, and the user terminal that is able to communicate with the information processing system and the management server, the method comprising:
acquiring device information from the information processing system by communicating with the information processing system;
transmitting to the management server the device information that is acquired;
acquiring the setting information corresponding to the device information from the management server; and
transmitting to the information processing system the setting information that is acquired.
